(19) United States
(12) Patent Application Publication
(10) Pub. No.: US 2008/0159111 A1
(43) Pub. Date: Jul. 3, 2008

(54) Optical Pickup Device

(75) Inventor: Taichi Akiba, Saitama (JP)

Correspondence Address: FOLEY AND LARDNER LLP;SUITE 500, 3000 K STREET NW, WASHINGTON, DC, 20007, US

(73) Assignee: Pioneer Corporation

(21) Appl. No.: 10/593,114

(22) PCT Filed: Mar. 17, 2005
(86) PCT No.: PCT/JP2005/004819

§ 371 Date: Sep. 18, 2006

(30) Foreign Application Priority Data
Mar. 19, 2004 (JP) 2004-080086

(51) Int. Cl. G11B 7/135

(52) U.S. Cl. 369/112.01

(57) ABSTRACT

An optical pickup apparatus includes an optical pickup, and a turntable for holding an optical recording medium is placed. A protective cover is arranged between the optical recording medium placed on the turntable and the optical pickup and protects the optical pickup. A heat conducting member connects the optical pickup and the protective cover, and conducts heat generated in the optical pickup to the protective cover.

### TECHNICAL FIELD

The present invention relates to a heat radiating mechanism in an optical pickup that guides a laser beam to an optical recording medium placed on a turntable and receives a return light from the optical recording medium.

### BACKGROUND ART

In a digital versatile disc (DVD)/compact disc (CD) recorder or a DVD/CD player that reads or writes information to or from an optical disc such as a DVD or a CD, an optical pickup includes components that radiate heat such as a semiconductor laser that is a light source for irradiating a beam to an optical disc, and an integrated circuit of a drive circuit that drives the semiconductor laser. In such an optical pickup, a semiconductor laser that emits a shorter wavelength is employed as a light source to satisfy demands for miniaturization, weight saving, and densification. Although such a shorter-wavelength semiconductor laser can produce a beam having a small diameter on an optical disc, the shorter-wavelength semiconductor laser has a disadvantage that to output the same power of a light, the shorter-wavelength semiconductor laser requires a larger electric power than, and because a larger electric power required, a heat generated in the semiconductor laser is large. For this reason, unless heat is efficiently radiated from the optical pickup, a substantial amount of heat gets accumulated, so that output of the optical pickup cannot be increased and life of the optical pickup is shortened.

Non-patent Document 1 discloses a semiconductor laser in which heat is radiated via a heat conductive sheet to a Peltier device that is outside an optical pickup.

Non-patent Document 1: Pioneer Corporation, Engineering Information Journal, PIONEER R&D, 1996, Vol. 7, No. 1.

### DISCLOSURE OF INVENTION

### Problem to be Solved by the Invention

However, according to a conventional technology described in the Non-patent Document 1, the Peltier device for radiating heat is newly provided, thereby creating problems in terms of cost and space, for example.

The present invention has been made in view of the above discussion. The object of the present invention is to provide a heat radiating mechanism for use in an optical pickup that is small, light, low-cost, and excellent in heat radiation.

### Means for Solving Problem

The invention disclosed in claim 1 includes an optical pickup that includes a laser light source, and irradiates a laser beam from the laser light source to an optical recording medium to at least one of record information on the optical recording medium and reproduce information from the optical recording medium; a turntable on which the optical recording medium is placed; a protective cover that is arranged between the optical recording medium placed on the turntable and the optical pickup, and protects the optical pickup; and a heat conducting member that is connected to the optical pickup and the protective cover, and conducts heat generated in the optical pickup to the protective cover.

### EFFECT OF THE INVENTION

According to the present invention, heat generated in an optical pickup is conducted via a heat conducting member to a protective cover that is generally provided for protecting the optical pickup 10 and a drive mechanism, thereby obtaining a heat sink with a large surface area. Furthermore, because the protective cover is directly blown with an air flow generated by turning a disc, thermal diffusion at the protective cover is efficient, so that a countermeasure, such as providing a radiating fin at the protective cover to improve radiation efficiency, is not required. Thus, a rise in temperature of a laser light source can be efficiently suppressed.

### BRIEF DESCRIPTION OF DRAWINGS

FIG. 1 is a schematic for explaining a heat radiating mechanism of an optical pickup apparatus according to a first embodiment of the present invention;

FIG. 2 is a schematic for explaining a heat radiating mechanism of an optical pickup apparatus according to a second embodiment of the present invention;

FIG. 3 is a schematic for explaining a heat radiating mechanism of an optical pickup apparatus according to a third embodiment of the present invention;

FIG. 4 is a perspective view of a heat radiating mechanism of an optical pickup apparatus according to an example 1 of the present invention;

FIG. 5 is a perspective view of an internal structure of the optical pickup apparatus according to the example; and

FIG. 6 is an exploded perspective view of an optical system installed on the optical pickup apparatus according to the example.

### EXPLANATIONS OF LETTERS OR NUMERALS

1 Turntable
2 Optical disc
10 Optical pickup
11 Pickup base
12 Holder for adjusting
13 Objective lens
14 Spring
20 Semiconductor laser
30 Protective cover
40, 41 Heat conducting members
45 Circuit board
46 Supporting frame
47 Flexible printed-circuit board
60 Semiconductor laser for DVD
61 Semiconductor laser for CD

### BEST MODE(S) FOR CARRYING OUT THE INVENTION

Exemplary embodiments and an example of a heat radiating mechanism of an optical pickup according to the present invention will be explained below in detail with reference to accompanying drawing.

### First Embodiment

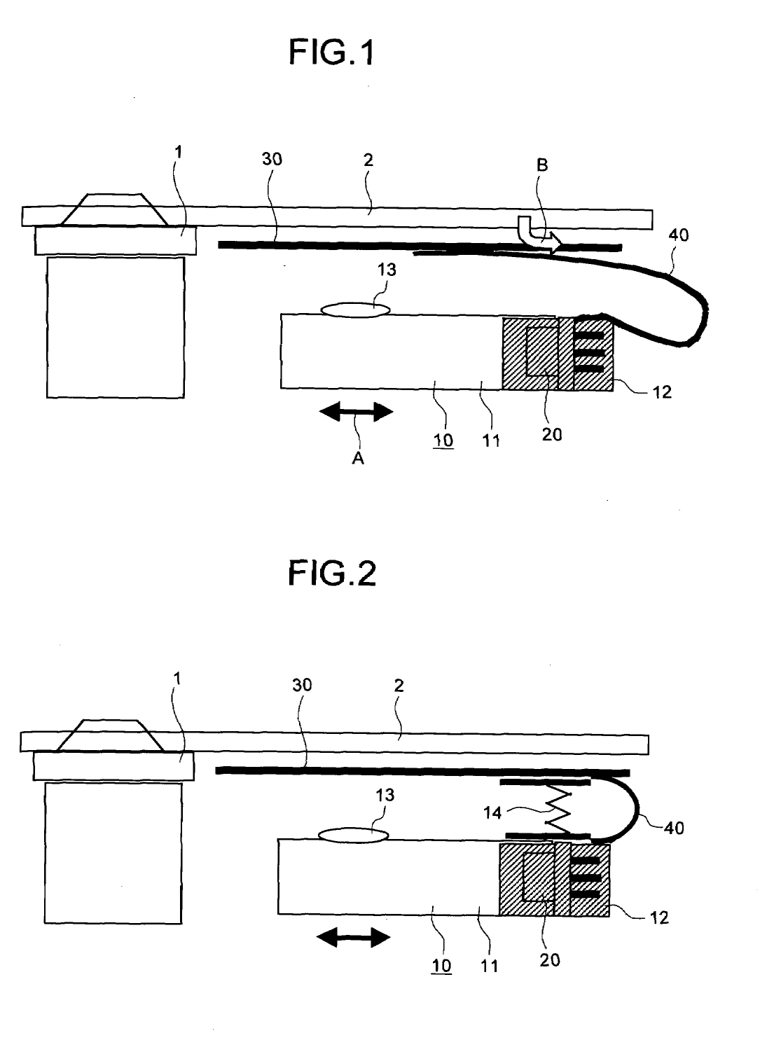

FIG. 1 is a schematic for explaining a heat radiating mechanism of an optical pickup apparatus according to a first embodiment of the present invention. In FIG. 1, an optical disc 2 (optical recording medium), such as a digital versatile disc (DVD) or a compact disc (CD), is placed on a turntable 1. An optical pickup 10 is arranged opposite to the optical disc 2. The optical pickup 10 is movable in a radial direction of the optical disc, i.e. a tracking direction (direction of arrow A). A semiconductor laser 20 is mounted on a pickup base 11 of the optical pickup 10 via a holder for adjusting 12. The holder for adjusting 12 adjusts a position and an angle of the semiconductor laser 20 with respect to the pickup base 11 such that an optical axis of the semiconductor laser 20 is aligned with an optical axis of an optical system in the optical pickup 10 by eliminating mounting deviation. An objective lens 13 installed on the optical pickup 10 is movable in the tracking direction A and in a focusing direction with respect to the pickup base 11. The holder for adjusting 12 is formed from a material excellent in thermal conductivity such as metal.

A protective cover 30 that provides a physical protection to prevent a user from touching a drive mechanism, such as the optical pickup 10 or a pickup carriage, is arranged between the optical disc 2 placed on the turntable 1 and the optical pickup 10. The protective cover 30 is fixed on a supporting frame (not shown) that movably supports the optical pickup 10. The protective cover 30 is formed from a material excellent in heat radiation such as aluminum or copper.

According to the first embodiment, the protective cover 30 serves as a heat sink. Specifically, the semiconductor laser 20 installed on the optical pickup 10 (precisely, semiconductor laser package) and/or the holder for adjusting 12 are/is thermally connected to the protective cover 30 with a heat conducting member 40 that is in the form of a ductile film. One end of the heat conducting member 40 is fixed to a bottom surface of the protective cover 30, while the other end is fixed to the semiconductor laser 20 or the holder for adjusting 12. It is preferable that the area of contact of the heat conducting member 40 with the protective cover 30 or the semiconductor laser 20 is large because that improves heat conductivity.

The ductile heat conducting member 40 is formed of, for example, a sheet made from carbon fiber, a metal sheet or foil of copper or aluminum, or a flexible printed-circuit board. The ductile heat conducting member 40 can be fixed to the corresponding part by, for example, bonding with a thermally conductive adhesive, a thermally conductive adhesive tape, a bond, soldering, or the like, crewing, clamping with a spring, binding with a presser part, or the like. It is preferable that the heat conducting member is ductile, because a ductile heat conducting member does not exert force onto the optical pickup 10 that is moving.

Thus, according to the first embodiment, heat generated in the optical pickup 10 is conducted via the heat conducting member 40 to the protective cover 30 that is generally provided for a purpose of protecting the optical pickup 10 and the drive mechanism, thereby obtaining a heat sink having a large surface area. Furthermore, because the protective cover 30 is directly blown with an air flow generated by turning a disc as shown with arrow B, thermal diffusion at the protective cover 30 is efficient, so that a countermeasure, such as providing a radiating fin at the protective cover to improve radiation efficiency, is not required. Thus, a rise in temperature of the semiconductor laser 20 can be efficiently suppressed.

Furthermore, unlike the conventional technology that additionally provides a heat radiating member, heat is radiated by using the protective cover 30 that has a large surface area and is already provided over the optical pickup, thereby obtaining an optical pickup that is small, light, and low-cost.

### Second Embodiment

FIG. 2 depicts a heat radiating mechanism of an optical pickup apparatus according to a second embodiment of the present invention. In the second embodiment, the heat conducting member 40 in the form of a ductile sheet is arranged between the optical pickup 10 and the protective cover 30. Moreover, a spring 14, which is an elastic member, presses a contact area of the heat conducting member 40 with the optical pickup 10 and a contact area of the heat conducting member 40 with the protective cover 30 away from each other. Precisely, one end of the spring 14 presses the optical pickup 10 via the heat conducting member 40, while the other end of the spring 14 presses the protective cover 30 via the heat conducting member 40.

The contact area of the heat conducting member 40 with the optical pickup 10 is fixed with, for example, an adhesive, while the contact area of the heat conducting member 40 with the protective cover 30 is not fixed. Accordingly, as the optical pickup 10 moves, the heat conducting member 40 and the spring 14 moves together. Precisely, as the optical pickup 10 moves, the contact area of the heat conducting member 40 with the protective cover 30 slides along with a bottom surface of the protective cover 30.

The contact area of the heat conducting member 40 with the protective cover 30 is appropriately processed to make a coefficient of friction small, whereby movement of the optical pickup 10 is not disturbed.

### Third Embodiment

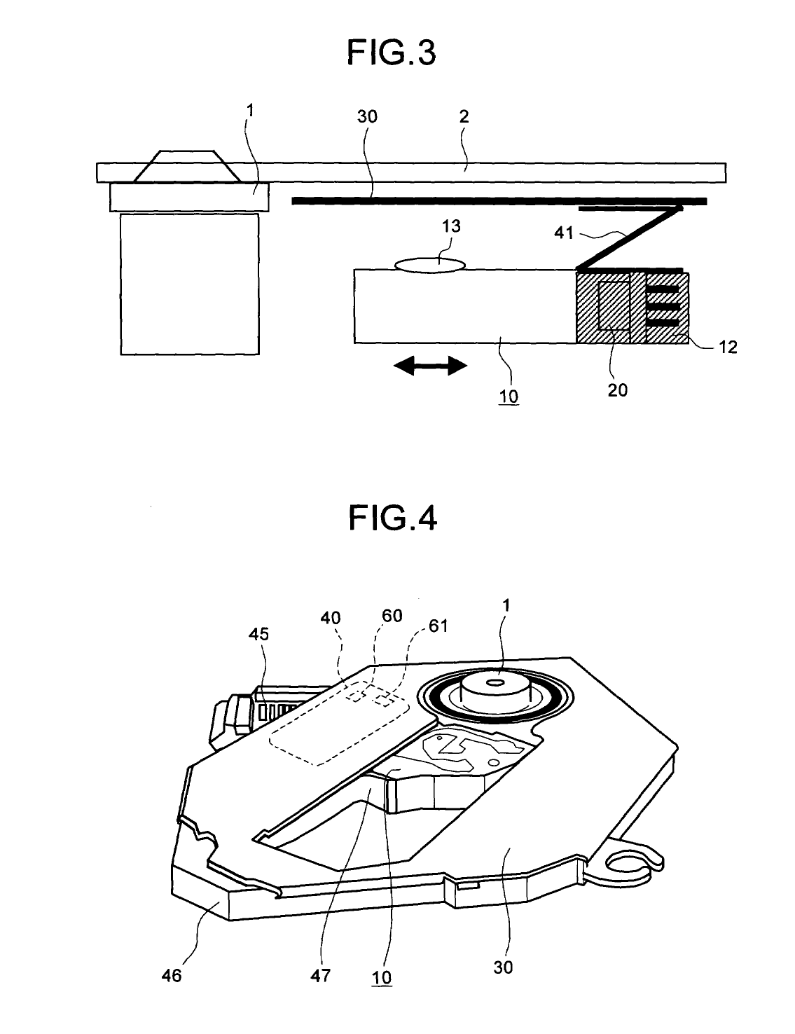

FIG. 3 depicts a heat radiating mechanism of an optical pickup apparatus according to a third embodiment of the present invention. In the third embodiment, a heat conducting member 41 that connects between the optical pickup 10 and the protective cover 30 is in the form of a plate spring. One end of the plate spring and the heat conducting member 41 is fixed to the optical pickup 10, the other end of the heat conducting member 41 is not fixed.

Accordingly, as the optical pickup 10 moves, the heat conducting member 41 moves together. Precisely, as the optical pickup 10 moves, a contact area of the heat conducting member 41 with the protective cover 30 slides along with a bottom surface of the protective cover 30. The contact area of the heat conducting member 41 with the protective cover 30 is appropriately processed to make a coefficient of friction small, whereby movement of the optical pickup 10 is not disturbed.

### Example 1

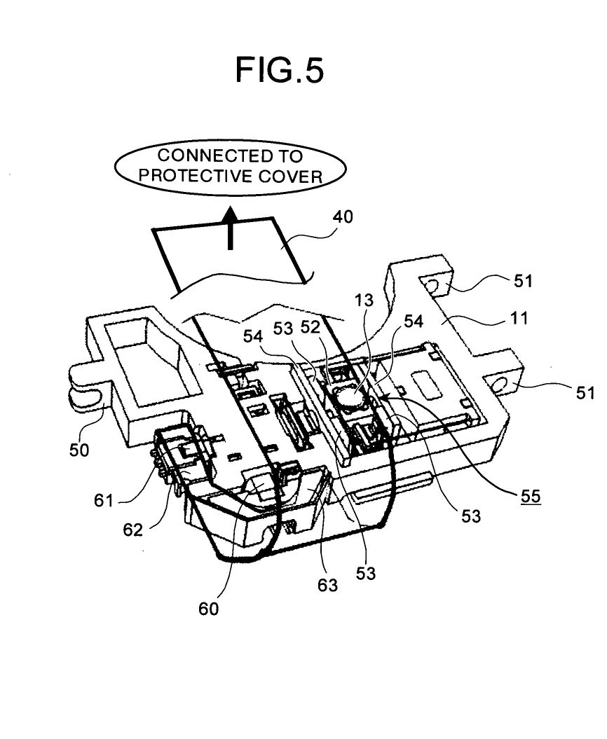

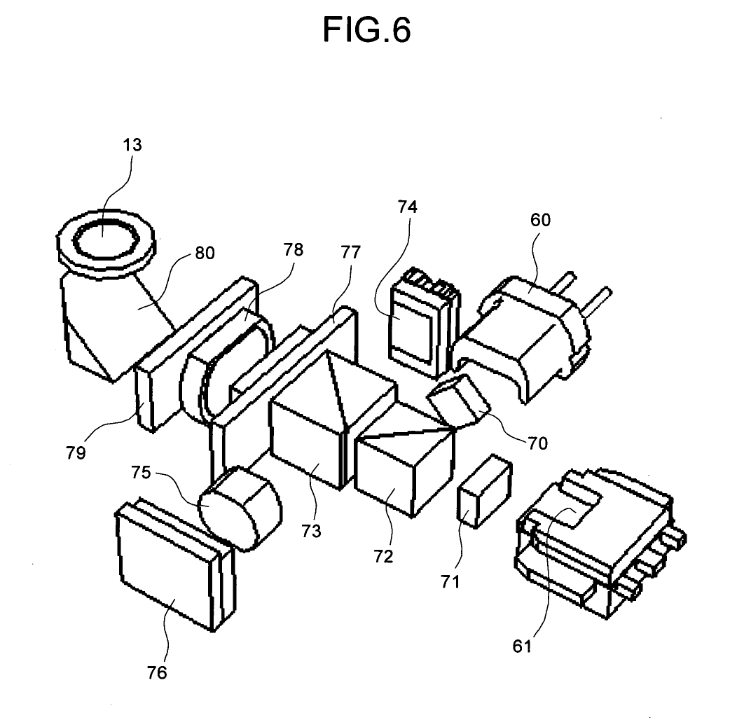

A concrete example according to the present invention is explained with reference to FIGS. 4 to 6. The optical pickup 10 in the example includes two semiconductor laser elements 60 and 61 for DVD and CD respectively. FIG. 4 is a perspective view of a pickup drive mechanism including the optical pickup 10. FIG. 5 is a perspective view of an internal structure of the optical pickup 10. FIG. 6 is a perspective view of an optical system in the optical pickup.

As shown in FIG. 5, the optical pickup 10 includes the pickup base 11. Components that form the optical pickup are installed on the pickup base 11. The pickup base 11 includes main bearings 51 and a sub-bearing 50 into which a main shaft and a sub shaft, both of which are not shown, are inserted, and is movable in the tracking direction by a pickup carriage (not shown). The pickup carriage is arranged under the protective cover 30 shown in FIG. 4.

The pickup base 11 has an opening on its upper side, in which the objective lens 13, an objective lens holder 52, and an actuator 55 that has an actuator moving part including a focus driving coil (not shown) and a tracking driving coil (not shown) and an actuator fixing part including magnets 53 and yokes 54, are provided. The actuator 55 moves the objective lens 13 in the tracking direction and the focusing direction with respect to the pickup base 11.

The optical pickup 10 includes the two semiconductor laser elements 60 and 61. The semiconductor laser element 60 emits a laser beam having a wavelength corresponding to a DVD. The semiconductor laser element 61 emits a laser beam having a wavelength corresponding to a CD. These semiconductor elements are selectively driven. The semiconductor laser element 61 corresponding to the CD is supported with a laser holder 62, and its three-dimensional position with respect to the pickup base 11 can be adjusted with the laser holder 62. The semiconductor laser element 60 corresponding to the DVD is supported with a laser holder 63, and its three-dimensional position with respect to the pickup base 11 and its upward, downward, rightward and leftward turning angle (attitude angle) can be adjusted with the laser holder 63.

Inside the pickup base 11, the optical system shown in FIG. 6 is accommodated. The optical system includes two gratings 70 and 71, a dichroic prism 72 that is an optical-path combining element, a beam splitter 73, a light receiving element 74 for a front monitor, a cylindrical lens 75, a light receiving element 76 having a quarterly-divided receiving surface, a liquid crystal aberration correction element 77, a collimator lens 78, a quarter-wave plate 79, a deflecting mirror 80, and the objective lens 13.

A laser beam emitted from the semiconductor laser element 61 for CD is divided into a plurality of lights (a zero-order diffraction light, a negative first-order diffraction light, and a positive first-order diffraction light) at the grating 71 for extracting a tracking error, and then enters the beam splitter 73 via the dichroic prism 72. A part of the laser beam, which has entered the beam splitter 73, is deflected and enters the light receiving element 74 for the front monitor, and then, for example, laser power of the laser beam is monitored. The rest of the laser beam permeates the beam splitter 73, is then corrected for aberration at the aberration correction element 77, is converted to a parallel ray through the collimator lens 78, permeates the quarter-wave plate 79, is then deflected by 90 degree with the deflecting mirror 80 to enter the objective lens 13, and is focused on an optical disc.

On the other hand, a laser beam emitted from the semiconductor laser element 60 for DVD enters the beam splitter 73 via the grating 70 and the dichroic prism 72. A part of the laser beam, which has entered the beam splitter 73, is deflected and enters the light receiving element 74 for the front monitor. The rest of the laser beam permeates the beam splitter 73, is then corrected for aberration at the aberration correction element 77, is converted to a parallel ray through the collimator lens 78, permeates the quarter-wave plate 79, enters the objective lens 13 via the deflecting mirror 80, and is focused on an optical disc.

A return light reflected at the optical disc permeates the objective lens 13, the deflecting mirror 80, the quarter-wave plate 79, the collimator lens 78, and the aberration correction element 77, and is then deflected with the beam splitter 73, and then enters the light receiving element 76 via the cylindrical lens 75. Based on a detection signal by the light receiving element 76, a focus error signal and a tracking error signal are created, and a reproduction signal that information recorded in the optical recording medium is demodulated and reproduced is acquired.

The optical pickup 10 configured as described above is mounted to the main shaft and the sub-shaft arranged inside a supporting frame 46 shown in FIG. 4 via the main bearings 51 and the sub-bearing 52 shown in FIG. 5. In the supporting frame 46, a pickup carriage (not shown) including a motor and a circuit board 45 are arranged. A flexible printed-circuit board 47 is connected to the circuit board 45.

As shown in FIG. 4, the protective cover 30 has an opening in a region in which the turntable 1 is provided and the objective lens moves. The protective cover 30 is fixed on the supporting frame 46 to prevent a user from touching the optical pickup 10, the pickup carriage, the circuit board 45, the flexible printed-circuit board 47 and the like.

To cause the protective cover 30 with a large surface area to serve as a heat sink, the heat conducting member 40 in the form of a ductile sheet is arranged between the optical pickup 10 and the protective cover 30. One end of the heat conducting member 40 is fixed to the two semiconductor laser 60 and 61 and the laser holders 62 and 63, while the other end of the heat conducting member 40 is fixed to a bottom surface of the protective cover 30.

Thus, in the example, heat generated in the optical pickup 10 is conducted to the protective cover 30 via the ductile heat-conducting member 40, thereby increasing a heat radiating surface area substantially. Furthermore, because the protective cover 30 is directly blown with an air flow generated by turning a disc, thermal diffusion at the protective cover 30 is efficient. Accordingly, a rise in temperature of the semiconductor laser 20 can be efficiently suppressed. Furthermore, unlike a conventional technology that additionally provides a heat radiating member, heat is radiated by using the protective cover 30 that is already provided over the optical pickup, thereby achieving an optical pickup that is small in size, light in weight, and low in cost.

As a subject matter to be radiated, not only a semiconductor laser but also any heat generating member installed on an optical pickup, for example, a laser driver that drives the semiconductor laser, or a high-frequency superposed integrated-circuit, can be radiated.

### INDUSTRIAL APPLICABILITY

Thus, the present invention can be applied to an optical-disc recording-reproducing device, a DVD/CD recorder, a DVD/CD player, a DVD/CD drive for computer, a next generation DVD using a blue-violet laser beam, and the like.

1-4. (canceled)

5. An optical pickup apparatus comprising:
an optical pickup that includes an optical pickup base on which a laser light source and an optical system are installed, wherein the optical system includes an objective lens movable in a focusing direction and a tracking direction, and at least one of records information on an optical recording medium and reproduces information from the optical recording medium with a laser beam from the laser light source;
a supporting frame that supports the optical pickup base movably in the tracking direction;
a turntable on which the optical recording medium is placed;
a protective cover that is arranged between the optical recording medium placed on the turntable and the optical pickup, fixed to the supporting frame, and protects the optical pickup; and
a heat conducting member that is connected to the optical pickup and the protective cover, and conducts heat generated in the optical pickup to the protective cover.

6. The optical pickup apparatus according to claim 5, wherein an end of the heat conducting member is connected to any one of a package that accommodates the laser light source on the optical pickup base and a holder that holds the package.

7. The optical pickup apparatus according to claim 5, further comprising an elastic member that presses the heat conducting member, wherein
an end of the heat conducting member is pressed by the elastic member, and fixed to the optical pickup; and
the other end of the heat conducting member is pressed by the elastic member, thereby making contact with the protective cover.

8. The optical pickup apparatus according to claim 5, wherein the heat conducting member is formed as a plate spring arranged between the optical pickup and the protective cover.
